(19) United States
(12) Patent Application Publication
(10) Pub. No.: US 2014/0122642 A1
(43) Pub. Date: May 1, 2014

(54) REMOTE MEMORY MANAGEMENT IN DISTRIBUTED M2M SYSTEMS

(71) Applicants: Robbin Hughes, Plano, TX (US); Ramesh Rajasekaran, Chennai (IN); Thomas John O'Neill, La Jolla, CA (US); Prem Jothipragasam Kumar, San Diego, CA (US); Arunkumar Dhananjayan, Chennai (IN)

(72) Inventors: Robbin Hughes, Plano, TX (US); Ramesh Rajasekaran, Chennai (IN); Thomas John O'Neill, La Jolla, CA (US); Prem Jothipragasam Kumar, San Diego, CA (US); Arunkumar Dhananjayan, Chennai (IN)

(21) Appl. No.: 13/666,861

(22) Filed: Nov. 1, 2012

(51) Int. Cl. G06F 15/16

(52) U.S. Cl. 709/217

(57) ABSTRACT

The embodiments herein relate to Machine to Machine (M2M) based systems and, more particularly, to managing application and services data in M2M based systems. The embodiments herein disclose a system and method for managing application and services data in a distributed wireless M2M system. Embodiments disclosed herein disclose direct transport of device configuration rules and processes sensor data to and from a back-end configuration and data management and to-from the sensors via intermediate concentrator devices within the M2M system.

### TECHNICAL FIELD

The embodiments herein relate to Machine to Machine (M2M) based systems and, more particularly, to managing application and services data in M2M based systems.

### BACKGROUND

Machine to Machine (M2M) systems comprise of an interconnected web of devices, wherein the devices use wired and/or wireless based communication networks to communicate with each other. The system may be a one to one system, wherein one device communicates with only one other device at a time. The device may also be a one to many system, wherein one device may communicate with multiple devices at the same time. The M2M system may be a centralized system, wherein the devices communicate via a centralized hub, wherein the hub performs analysis on data received from devices, before forwarding the data and/or analysis to the other devices. The M2M system may also be a peer to peer system, wherein the devices communicate to each other directly; wherein analysis may be performed at the source device or the destination device(s).

Currently in distributed M2M networks, application and services data, device configuration rules and processed sensor data are stored in the sensor or intermediate concentrator memory and are eventually transported to a back-end server with several stops along the way in memory. Due to the multiple stops along the way, there is a time delay involved in accessing application and services data, device configuration rules and processed sensor data.

### BRIEF DESCRIPTION OF THE FIGURES

The embodiments herein will be better understood from the following detailed description with reference to the drawings, in which:

FIG. 1 is a diagram of a M2M system, as disclosed in the embodiments herein; and

FIG. 2 is a block diagram of a M2M platform, as disclosed in the embodiments herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

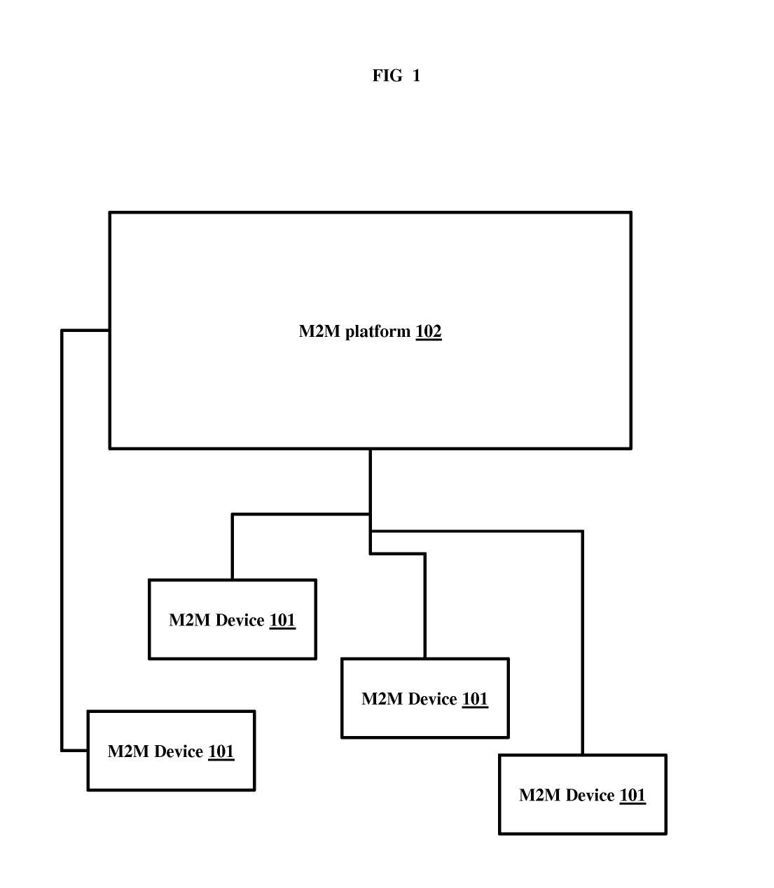

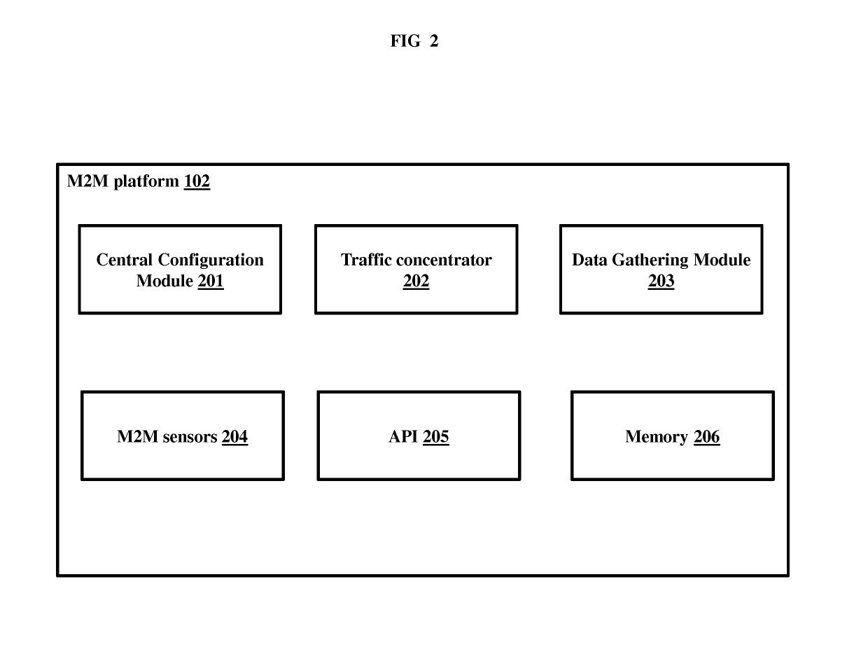

The embodiments herein disclose a system and method for managing application and services data in a distributed wireless M2M system. Referring now to the drawings, and more particularly to FIGS. 1 through 2, where similar reference characters denote corresponding features consistently throughout the figures, there are shown embodiments.

Embodiments disclosed herein disclose direct transport of device configuration rules and processes sensor data to and from a back-end configuration and data management and to-from the sensors via intermediate concentrator devices within the M2M system.

FIG. 1 is a diagram of a M2M system, as disclosed in the embodiments herein. The M2M system comprises of a plurality of M2M devices 101 connected to a M2M platform 102. The M2M devices 101 may be any device capable of communicating with at least one external device. The M2M device 101 may be any device configured to communicate with at least one external device using an external module connected to the M2M device 101 using a suitable means, wherein the suitable means may be a USB port, VGA port, a mini USB port, a micro USB port and so on. In another embodiment herein, the M2M device 101 may be configured to connect to communicate with at least one external device using an internal module present within the M2M device 101. Examples of the M2M device 101 are but not restricted to refrigerators, television sets, microwaves, computers, mobile phones, phones, PDAs, tablets, ovens, washing machines and so on. The M2M device 101 may communicate with the M2M platform 102 using any suitable communication means such as a cellular technology based communication network, a Wi-Fi network, a Bluetooth network, a Near Field Communication (NFC) based network, a ZigBee based network and so on.

The M2M platform 102 provides transport processing and storage of payload data. The M2M platform 102 comprises a means for receiving software and commands to generate an update and to report status, wherein the status may be reported back to at least one network operator. The M2M platform 102 can further specify, on receiving at least one command from a user or the network operator, the type of transport processing to be done to data. The M2M platform 102 is further configured for creating a downloadable image with the desired transport processing. The data may be fetched from a remote location such as a server. The M2M platform 102 is configured for downloading transport updates in to the M2M devices 101. The M2M platform 102 may hold the updates in a suitable location. The M2M platform 102 is further configured to restart the M2M devices 101 and running the new updates on the M2M devices 101. The M2M platform 102 provides a means for displaying the status of the update and versioning status.

FIG. 2 is a block diagram of a M2M platform, as disclosed in the embodiments herein. The M2M platform 102, as depicted, comprises of a central configuration module 201, a traffic concentrator module 202, a data gathering module 203, a plurality of M2M sensors 204, a plurality of APIs 205 and a memory 206.

The traffic concentrator module 202 provides transport processing and storage of payload data. The traffic concentrator module 202 comprises a means for receiving software and commands to generate an update and to report status, wherein the status may be reported back to at least one network operator. The payload data may be fetched from a remote location and may be transported to and from the plurality of M2M sensors 204, wherein the M2M sensors 204 comprise of a plurality of sensors using cellular technology, Wi-Fi, Bluetooth, Near Field Communication (NFC), ZigBee and so on. The rules for triggering of sensors, scaling and ranging, and first-level processing, are maintained in the remote location and pushed down into the M2M sensors 204 via the traffic concentrator module 202 as a transient application as-needed and changed as-desired. The traffic concentrator module 202 transports the payload data directly to the remote location for further processing.

The central configuration module 201 can specify, on receiving at least one command from a user or the network operator, the type of transport processing to be done to data. The central configuration module 201 is further configured for creating a downloadable image with the desired transport processing. The central configuration module 201 is configured for downloading transport updates in to the M2M devices 101.

The central office configuration module 201 is further configured for automatically downloading updates into the M2M devices 101, holding these updates in the memory 206, and restarting the M2M devices 101 to accept and run the new update.

The central office configuration module 201 further provides a display of current device update status and versioning for a network operator, wherein the network operator may connect to the M2M platform 202 using the API 205.

The data gathering module 203 fetches data related to the M2M devices 101 and the related updates and stores the data in the memory 206.

Embodiments herein provides for more flexible user control of the M2M system since rules for triggering of sensors, scaling and ranging, and first-level processing, are maintained in the back-end server and pushed down into the sensor as a transient application as-needed and changed as-desired. The network can be easily completely reconfigured and changes pushed into the sensors, and payload data is not stored along the way but immediately transported back to the back-end server for further processing.

The embodiments disclosed herein can be implemented through at least one software program running on at least one hardware device and performing network management functions to control the network elements. The network elements shown in FIG. 2 include blocks, which can be at least one of a hardware device, or a combination of hardware device and software module.

The embodiment disclosed herein specifies a system and method for managing application and services data in a distributed wireless M2M system. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device, which can be programmed including e.g. any kind of computer like a server or a personal computer, or the like, or any combination thereof, e.g. one processor and two FPGAs. The device may also include means, which could be e.g. hardware means like e.g. an ASIC, or a combination of hardware, and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the embodiment may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

We claim:

1. A method for managing data in at least one device in a Machine to Machine (M2M) system, the method comprising of
pushing data from a remote location directly into a sensor on a M2M platform, on detecting a requirement for the data on the device; and
sending data from the sensor into the device by the M2M platform.

2. The method, as claimed in claim 1, wherein the method further comprises of changing the data, on detecting a requirement for a change in the data.

3. The method, as claimed in claim 1, wherein the method further comprises of the sensor receiving the data through a traffic concentrator module.

4. A Machine to Machine (M2M) system for managing data in at least one device in the Machine to Machine (M2M) system, the system configured for
receiving data pushed from a remote location directly into a sensor on the M2M platform, on the M2M platform detecting a requirement for the data on the device; and
sending data from the sensor into the device.

5. The system, as claimed in claim 4, wherein the system is further configured for changing the data, on detecting a requirement for a change in the data.

6. The system, as claimed in claim 4, wherein the sensor is configured for receiving the data through a traffic concentrator module.

7. A method for managing data in at least one device in a Machine to Machine (M2M) system, the method comprising of
receiving data by a sensor on a M2M platform from the device; and
pushing data by the sensor to a remote location directly.

8. The method, as claimed in claim 7, wherein the method further comprises of changing the data, on detecting a requirement for a change in the data.

9. The method, as claimed in claim 7, wherein the method further comprises of the sensor sending the data through a traffic concentrator module.

10. A Machine to Machine (M2M) system for managing data in at least one device in the Machine to Machine (M2M) system, the system configured for
receiving data by a sensor on the M2M platform from the device; and
pushing data by the sensor to a remote location directly.

11. The system, as claimed in claim 10, wherein the system is further configured for changing the data, on detecting a requirement for a change in the data.

12. The system, as claimed in claim 10, wherein the sensor sends the data through a traffic concentrator module.
